(19) United States
(12) Patent Application Publication
(10) Pub. No.: US 2007/0152557 A1
(43) Pub. Date: Jul. 5, 2007

(54) Light transmitting sparkplug

(76) Inventor: Thomas G. Packard, Edmonds, WA (US)

Correspondence Address: THOMAS G. PACKARD, 7005 150th PL. SW., EDMONDS, WA, 98026, US

(21) Appl. No.: 11/646,082

(22) Filed: Dec. 27, 2006

Related U.S. Application Data
(60) Provisional application No. 60/755,441, filed on Dec. 31, 2005.

(51) Int. Cl. H01T 13/00; F02M 57/06; H01T 13/48

(52) U.S. Cl. 313/129; 313/11.5; 313/118

(57) ABSTRACT

An internal combustion engine sparkplug and glow plug are constructed to conduct and transmit visible combustion generated light from the inner combustion chamber to the combustion chamber and engine exterior by means of an visible light conducting, transmitting, high temperature stable, inert and electrically insulating material. that surrounds or is adjacent to the central electrode.

### CROSS REFERENCE TO RELATED APPLICATIONS

PROVISIONAL APPLICATION 60/755,441 FILIND DATE Dec. 31, 2005

### STATEMENT REGARDING FEDERALLY SPONSORED DEVELOPMENT

NOT APPLICABLE.

### BACKGROUND OF THE INVENTION

Internal combustion engines often have problems relating to air, fuel ignition in the combustion chamber. These ignition/combustion problems can be difficult to localize as they are not directly visible.

The disclosed invention is a ignition plug, sparkplug, glow plug that will transmit sufficient visible combustion light from the combustion chamber to the external environment such that the firing conditions within the combustion chamber can be readily ascertained, visualized.

### BRIEF SUMMARY OF THE INVENTION

The invention is a sparkplug or glow plug for an internal combustion engine that Is visible light transmitting. A sparkplug is constructed wherein the center electrode is surrounded with a thickness of light transmitting/ conducting material that is also a strong durable, inert, high temperature and electrically insulating. This thickness of light conducting material is locked or fused to the center electrode on the inner side and the metallic outer body on the outside by a thin layer of porcelain material to facilitate manufacture. A related constructed is wherein the center electrode fused to a surrounding light conducting/transmitting material without the intervening porcelain. A glow plug is constructed wherein the inner metallic tube contains an inner tube or rod of stable light conducting/transmitting material that extends from the inner combustion chamber side to the outside of the chamber and glow plug. The inner metallic tube has ports or holes on the metal sides of the tube to allow visible combustion light to enter the tube and be transmitted the external side of the plug and engine

### BRIEF DESCRIPTION OF THE DRAWINGS

FIG. I Sparkplug with light transmitting/conducting electrical insulator and also ceramic type insulator.

FIG. 2 Spark plug with light conducting/transmitting electrical insulator.

FIG. 3 Glow plug with internal to external, light conducting/transmitting high temperature electrical insulator.

### DETAILED DESCRIPTION OF THE INVENTION

A sparkplug FIG. 1 is constructed in which the insulator between the Center electrode and the sparkplug body FIG. 1(1) is constructed from A material or materials that are light transparent in part or total in addition to having the required electrical, thermal and structural properties. The material can be fused silica, quartz, alumina, zircon, a high temperature glass, a high temperature metal oxide, a ceramic, or a similar type of material, that is pure or mixed. One construction is a silica tube FIG. 1(1), vycor, approximately 2½ inch in length by 5/16 inch o.d. by ⅛ inch i.d. that would be abraded or etched as necessary. The center metallic electrode FIG. 1(2) with resister FIG. 1(3) would be in the tube surrounded by a Ceramic material that upon heat treating would be fused to porcelain FIG. 1(4) thus locking the electrode and resister in the tube.

The resulting tube containing electrode would be partially contained within the sparkplugs outer metal body FIG. 1(5) or shell and also be fused and locked in place upon heat treating to the metal body by a ceramic, porcelain layer FIG. 1(7) or ring. The ceramic could also be glazed if necessary to assist bonding etc. The tip and body of the tube that are exposed in the combustion chamber would be profiled FIG. 1(6) as necessary and would conduct combustion generated visible light through the sparkplug to the external environment.

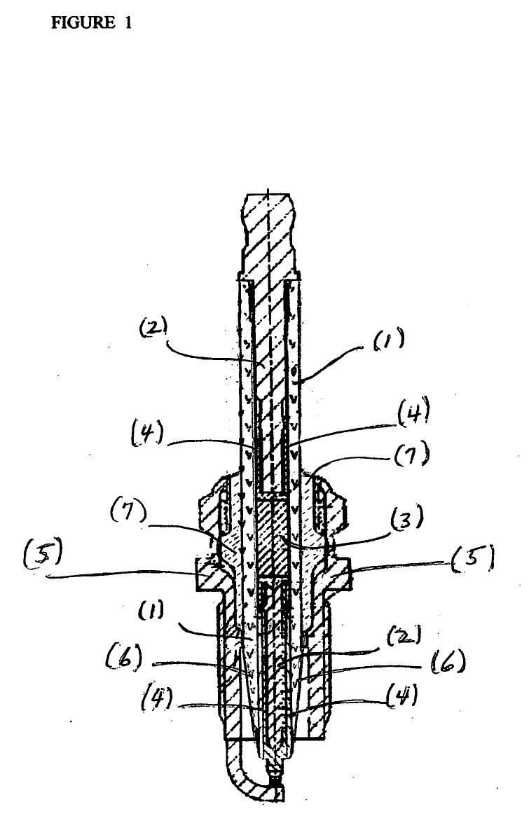

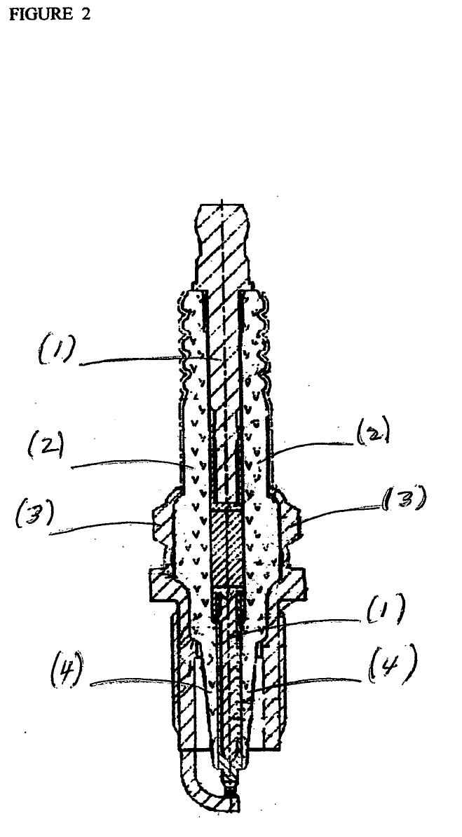

Another construction would be a sparkplug wherein the center electrode FIG. 2(1) and Resister are surrounded by a layer of high temperature, transparent, clear, electrically insulating glass FIG. 2(2) that would extend to the inner side of the metal body of the sparkplug FIG. 2(3), as appropriate and be profiled, shaped FIG. 2(4), as appropriate.

The whole assemble would be fused together by the cooling of the melted glass. The glass would be hot molded or as a glass power in the mold followed by heating and cooling.

The resulting sparkplug is light transmitting.

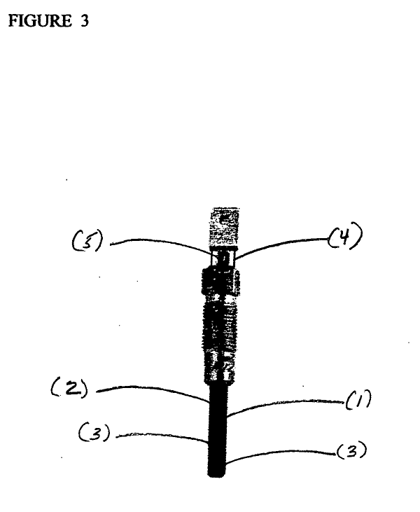

A light conducting glow plug FIG. 3, is also constructed by inclosing or surrounding the center internal electrode and extending to the electrode tip end area or tip heating element FIG. 3, 1 in an internal, transparent high temperature, electrical insulating material, quartz, Sio2, vycor glass, zircon, alumina, etc. The metal shell FIG. 3, 2 of the heater probe will have a ports area FIG. 3, 3 or holes that expose the inner light conducting insulator to the combustion chamber interior.

The external exterior of the metal electrode that is external to the combustion chamber and engine will have an area FIG. 3, 4 or port to allow visible light to be transmitted to outer external environment from the light conducting insulator that surrounds part of the external extending electrode FIG. 3, 5

The visible light conducting insulator may also be partially surrounded by a general sealing ceramic insulator. As most engines have multiple cylinders, light emitting glow plugs can be of some diagnostic value.

1. I claim an internal combustion engine visible light conducting and transmitting sparkplug that has a center electrode surrounding insulating body that is light transparent and conducting from the interior of the combustion chamber to the external exterior of the combustion chamber and engine.

2. I claim an internal combustion engine visible light conducting and transmitting sparkplug that has a center electrode which surrounded with an insulating body that is constructed of one or more different insulating materials one of which will conduct and transmit significant visible combustion generated light from the interior of the combustion chamber to the external exterior of the combustion chamber and engine.

3. Claim 1 wherein, the internal combustion engine spark plug has an external exterior of the external center electrode assembly that is constructed of a visible light conducting and transmitting and electrically insulating material.

4. Claim 1 wherein, the sparkplug in which the combustion chamber interior and exterior portions are both insulating and visible light conducting, transparent and the sparkplugs center electrodes interior terminal end is surrounded with the insulating and visible light conducting material.

5. Claim 2 wherein, the internal combustion engine sparkplug has an external exterior of the external electrode assembly that is constructed of a visible light conducting and transmitting and electrically insulating material.

6. Claim 2 wherein, the sparkplug in which the interior and exterior portions are both electrically insulating and visible light conducting, transparent and the center electrodes interior terminal end is surrounded with the electrically insulation and visible light conducting material.

7. I claim an internal combustion engine glow plug that is constructed in such a fashion and of such materials that will allow the conduction and transmission of visible light from the internal combustion chamber to the exterior of the combustion chamber and engine.

8. Claim 7 wherein, the glow plug has a center electrode that is is surrounded with a light conducting and transmitting material in such a fashion as to allow visible combustion light to be transmitted to the external exterior of the combustion chamber, glow plug and engine.

9. Claim 7 wherein, the glow plug with a probe or bayonet that allows visible combustion generated light to be conducted to the interior of the probe or bayonet and then to the exterior of the combustion chamber and engine.
